(19) United States
(12) Patent Application Publication
(10) Pub. No.: US 2022/0257044 A1
(43) Pub. Date: Aug. 18, 2022

(54) APPARATUSES, SYSTEMS, AND METHODS FOR BREWING A BEVERAGE

(71) Applicant: Starbucks Corporation, Seattle, WA (US)

(72) Inventors: Natarajan Venkatakrishnan, Bellevue, WA (US); Joseph Emil Gormley, Mercer Island, WA (US)

(21) Appl. No.: 17/175,196

(22) Filed: Feb. 12, 2021

(51) Int. Cl. A47J 31/42; A47J 31/10; A47J 31/44

(52) U.S. Cl. CPC A47J 31/42; A47J 31/4403; A47J 31/10

(57) ABSTRACT

Apparatuses, systems, and methods for brewing a desired portion of a beverage, such as an individual serving portion of coffee, are provided. Certain aspects of this disclosure are directed toward a bulk hopper replacement unit, or individual serving feed hopper adapter, that is configured to be docked with an open hopper slot of a bulk hopper assembly of an existing automated bulk coffee brewing system that is typically used to prepare bulk beverages using coffee beans stored in bulk hoppers connected to the system. For example, the individual serving feed hopper adapter can advantageously allow the existing automated bulk coffee brewing system to prepare an individual serving portion of a particular beverage that involves use of ingredients (e.g., coffee beans) that are not currently stored in one of the bulk hoppers.

### CROSS-REFERENCE TO RELATED APPLICATIONS

This application is related to U.S. Pat. No. 9,930,987, which is hereby incorporated by reference in its entirety.

### FIELD

The present disclosure generally relates to a bulk hopper replacement unit that allows for a smaller portion, such as, a single-cup portion or an individual serving portion of a beverage (e.g., coffee) to be brewed after engaging the bulk hopper replacement unit with an existing bulk hopper slot of an automated bulk beverage preparation system (e.g., automated bulk coffee brewing system).

### BACKGROUND

Many methods and systems for brewing beverages, such as coffee, are known. Existing commercial coffee brewing systems include multiple hopper slots each storing different coffee beans to facilitate bulk preparation of multiple different coffee beverages. Such beverage brewing systems are limited, however, to preparing coffee beverages that use the coffee beans stored in the hoppers.

### SUMMARY

Automated bulk coffee brewing systems (e.g., a Clover® automated brewing system provided by Starbucks Coffee Company) may be employed in a commercial coffee store or coffee house to improve the accuracy and repeatability of providing individual service portions, such as single-cup portions or traveler portions (e.g., multiple-cup portions) of commonly-ordered coffee beverages and do so in an efficient manner. For example, the same grinder assembly and brew assembly can advantageously be used to prepare individual serving (e.g., single-cup) portions of the coffee beverages using coffee beans stored in multiple different hoppers, or storage containers. However, if a store patron orders a coffee beverage that requires different coffee beans than those in one of the hoppers currently installed on the automated bulk coffee brewing system, a barista may be required to use a different coffee preparation machine (e.g., a French press coffee maker or a pour-over coffee brewer) to prepare an individual serving (e.g., single-cup) portion of the desired coffee beverage. This can result in inefficiency (e.g., reduced throughput, additional cleaning time, additional preparation time), additional required equipment (and thus additional space in a small beverage and/or food preparation area), and a reduction in customer satisfaction due to longer wait times and/or a lack of automation expectations.

Certain aspects of this disclosure are directed toward a bulk hopper replacement unit, or individual serving feed hopper adapter, that allows a barista or other user to brew individual serving portions of different beverages (e.g., coffee beverages) using a single automated bulk beverage preparation system (e.g., a Clover® automated brewing system used commercially in coffee stores operated by Starbucks Coffee Company). For example, the bulk hopper replacement unit, or individual serving feed hopper adapter, includes an adapter component, or module, that is configured to removably engage with (be installed on or within, be mated with, docked with, or coupled to) an open hopper slot of a bulk hopper assembly of the automated bulk beverage preparation system (e.g., automated bulk coffee brewing system). The adapter component may comprise, for example, a mounting dock that takes the place of a bulk hopper (e.g., fits within an existing bulk hopper slot and engages or interfaces with components or mechanisms that a conventional bulk hopper would, such as a hopper motor, a chute leading to a grinder assembly, a hopper selector assembly, etc.).

The bulk hopper replacement unit can also include a vessel component, or module, configured to removably mate or engage with the adapter component (e.g., mounting dock). The vessel component may be engaged, mated, or otherwise coupled with the adapter component prior to or after engagement of the adapter component with the bulk hopper slot. Multiple individual serving vessel components can be pre-loaded with appropriate coffee bean ingredients for a respective desired coffee beverage and then lined, or queued, up to be interchangeably engaged with the adapter component in order to prepare the various individual serving portions of the respective coffee beverages using the automated bulk beverage preparation system (e.g., automated bulk coffee brewing system). In accordance with several implementations, the bulk hopper replacement unit may obviate the need for French press or pour-over coffee makers in a coffee store.

The vessel component can include a slide gate or other retention mechanism that retains the contents (e.g., coffee beans) needed to prepare an individual serving portion of a desired beverage within an interior volume of a temporary storage vessel, or container, until the vessel component is engaged with the adapter component. Upon engagement of the vessel component with the adapter component, the slide gate or other retention mechanism is automatically moved or transitioned to a second configuration (e.g., open or unlocked configuration) in which the contents of the storage container of the vessel component are allowed to exit the storage vessel (e.g., are no longer retained by the slide gate or other retention mechanism). In other implementations, the slide gate or other retention mechanism is manually moved or transitioned between the first and second configurations.

The adapter component may include an opening configured to receive the contents of the storage vessel, or container, of the vessel component upon removal of the slide gate or other retention mechanism. The adapter component can include a feeding auger disposed at least partially within an interior volume of the adapter component to facilitate controlled metering of the contents (e.g., coffee beans) received from the vessel component into a grinding assembly of the automated beverage preparation system (e.g., bulk coffee brewing system). The components, or modules, of the bulk hopper replacement unit can be disassembled without any tools to facilitate cleaning. The adapter component may also include a hopper motor connected to the auger. The hopper motor can turn the auger in a clockwise direction and a counter-clockwise direction. In other implementations, the hopper motor is a component of the hopper assembly of the automated beverage preparation system (e.g., bulk coffee brewing system).

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No aspects of this disclosure are essential or indispensable.

### BRIEF DESCRIPTION OF THE DRAWINGS

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1A illustrates a perspective view of an automated bulk coffee brewing system with which embodiments of a bulk hopper replacement unit, or individual serving feed hopper system, disclosed herein can be used.

FIG. 1B illustrates a front view of the automated bulk coffee brewing system shown in FIG. 1A.

FIG. 1C illustrates a rear view of the automated bulk coffee brewing system shown in FIG. 1A.

FIG. 1D illustrates a side cross-section view of the automated bulk coffee brewing system shown in FIG. 1A.

FIG. 1E illustrates a front cross-section view of the automated bulk coffee brewing system shown in FIG. 1A.

FIG. 2 illustrates a schematic block diagram of an automated beverage preparation system.

FIGS. 3A and 3B illustrate two perspective views of an embodiment of a bulk hopper replacement unit with its two main components coupled together. FIG. 3C illustrates a perspective view of the bulk hopper replacement unit with the two main components separated.

FIGS. 4A-4C illustrate operation of a retention member of the bulk hopper replacement unit shown in FIGS. 3A-3C. FIG. 4A shows a perspective view with the retention member removed from a coffee vessel component of the bulk hopper replacement unit. FIG. 4B shows a cross-section view of the coffee vessel component with the retention member in a closed configuration. FIG. 4C shows a bottom perspective view of the coffee vessel component with the retention member in a closed configuration.

FIG. 5A illustrates a perspective side cross-section view of the bulk hopper replacement unit shown in FIG. 3A.

FIG. 5B illustrates another cross-section view of the bulk hopper replacement unit shown in FIG. 3A.

FIGS. 6A-6D illustrate another embodiment of a bulk hopper replacement unit that may be used with the automated bulk coffee brewing system of FIGS. 1A-1E.

FIGS. 7A and 7B illustrates an example of how an embodiment of the bulk hopper replacement units described herein may be used with the automated bulk coffee brewing system of FIGS. 1A-1E. In FIG. 7A, the bulk hopper replacement unit is shown mounted on one of the hopper slots of a bulk hopper assembly of the automated bulk coffee brewing system. In FIG. 7B, a vessel component of the bulk hopper replacement unit is removed from the adapter component and the adapter component remains installed for further use with the same or a different vessel component.

### DETAILED DESCRIPTION

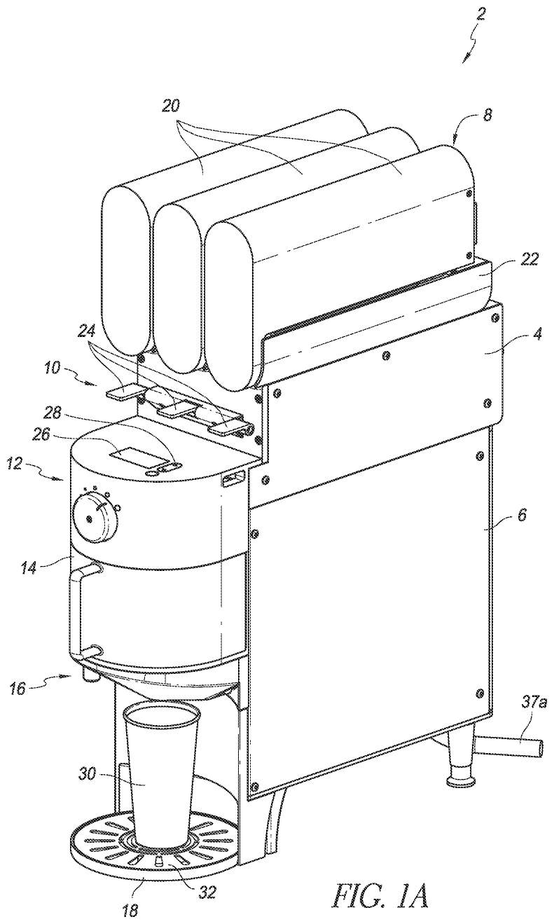

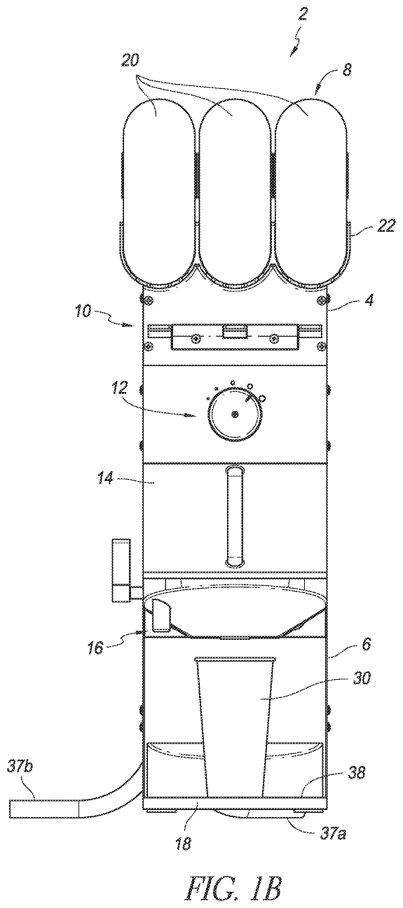

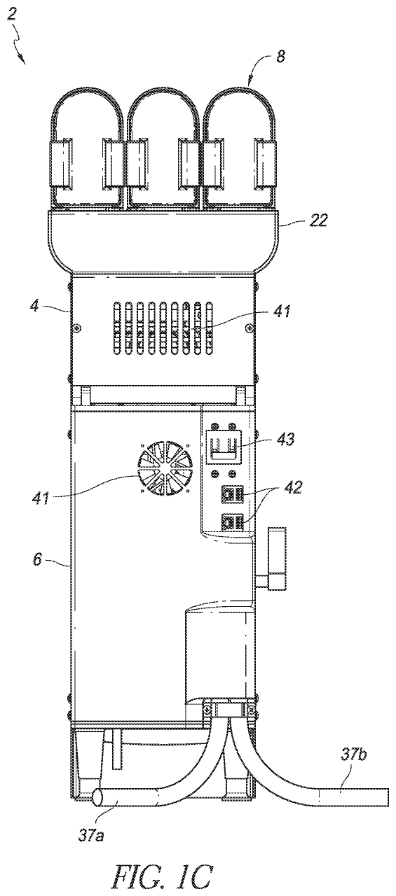

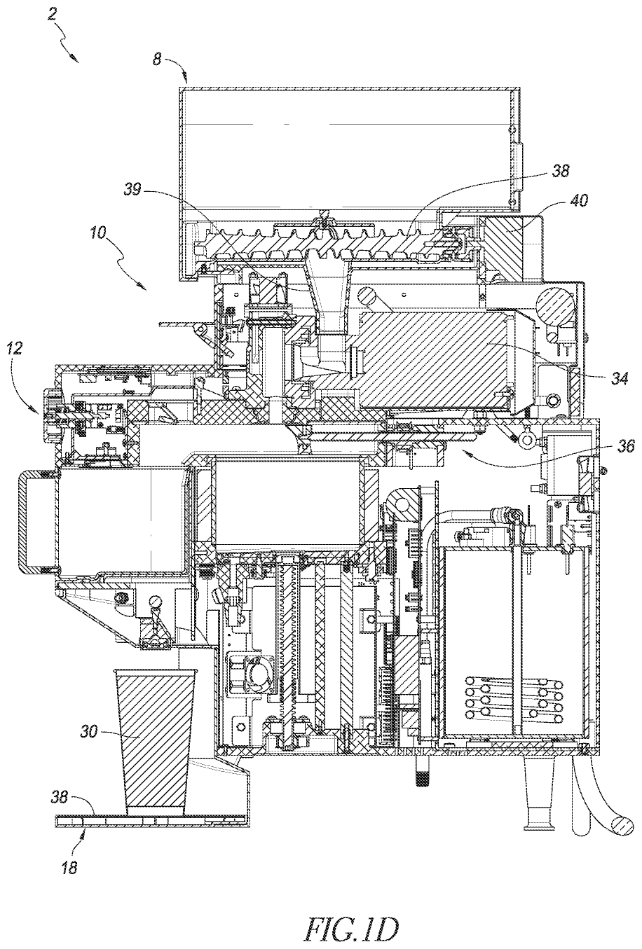

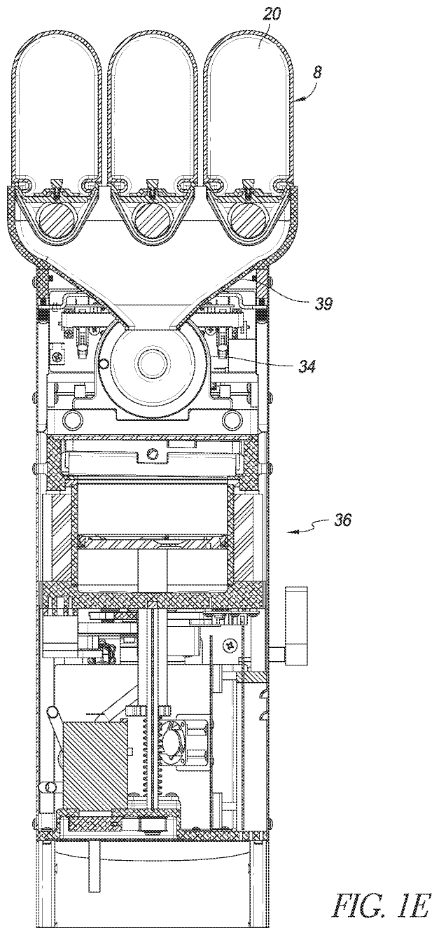

FIGS. 1A-1E illustrate an exemplary embodiment of an automated bulk coffee brewing system 2 designed to quickly and automatically brew an individual serving portion, such as a single-cup portion or a traveler portion (e.g., multiple-cup portion) of a coffee beverage. In general, the coffee brewing system 2 can include an upper portion 4 and a lower portion 6. The upper and lower portions 4, 6 house the internal components, including the grinder assembly 34 and the brewing assembly 36 (shown in FIG. 1D). The external components include a bulk hopper assembly 8, a hopper selector assembly 10, a user interface assembly 12, a waste bin assembly 14, a dispending assembly 16, and a base portion 18.

As mentioned above, the coffee brewing system 2 allows a user to quickly and easily brew a variety of types of single-cup or traveler portions of a coffee beverage in bulk. To accommodate different types of coffee beverages, the bulk hopper assembly 8 of the coffee brewing system 2 is adapted to receive multiple hoppers 20, each of which can hold a different type of coffee beverage material (e.g., dark roast coffee beans, medium roast coffee beans, light roast coffee beans, and/or decaffeinated coffee beans). The bulk hopper assembly 8 of the coffee brewing system 2 may be configured to receive three bulk hoppers (as shown) or more or less than three hoppers.

The bulk hopper assembly 8 can be positioned above the upper portion 4 of the coffee brewing system 2. For example, the bulk hopper assembly 8 can include a hopper retainer 22 for retaining the hoppers 20. The hopper selector assembly 10 includes a number of paddles 24 that can be used to select one or more of the hoppers 20 based on the desired beverage materials (e.g., types of coffee beans). Further, the paddles 24 can mechanically reset to indicate completion of a brew cycle. Each paddle 24 corresponds to a separate hopper slot. The paddles 24 can be aligned with the hoppers 20. Alignment of the paddles 24 with the hoppers 20 can provide visual confirmation of the correspondence between each paddle 24 and a selected hopper slot.

Depression of one or more of the paddles 24 can initiate a brew cycle for the coffee beverage system 2. Depression of one or more of the paddles 24 activates a controlled feed assembly (e.g., auger 38) of one or more of the hoppers 20. The paddles 24 can end a brew cycle (e.g., before dispensing of a beverage) upon manual release (e.g., lifting) of one or more of the paddles 24. The paddles 24 and/or augers 38 can be configured to provide visual confirmation to a user of the device and/or to a customer when a specific hopper is selected. For example, selection of one or more paddles can initiate agitation of the contents of the respective hoppers which may be viewable from outside of the coffee beverage system 2.

The user interface assembly 12 can include a display screen 26 that can display data or information relating to the coffee brewing system 2, such as beverage parameters, settings, or maintenance reminders. The coffee brewing system 2 can also include a display control 28 to control the type of information being displayed or input specific parameters or settings. The display screen may comprise a touch screen display or multiple input buttons to scroll through and select menu options. The waste bin assembly 14 includes a receptacle to receive “spent” coffee grounds after brewing. The receptacle may be removable to facilitate emptying of its contents.

The dispensing assembly 16 facilitates dispensing of the brewed coffee beverage into a container 30 placed on the base portion 18. The base portion 18 can include a drip plate 32 to capture any spilled beverage. The base portion 18 can be in fluid communication with a drain.

With reference to FIG. 1D, the interior components of the coffee brewing system 2 may include a grinder assembly 34 and a brewing assembly 36. The hoppers 20 include a feed auger 38 and a hopper motor 40. The hopper motor 40 is configured to rotate the feed auger 38 and the feed auger is configured to provide controlled doses of coffee beans to the grinder assembly 34. With reference to FIG. 1E, the grinder assembly 34 is positioned below the hoppers 20 and the hopper assembly 8 may include a tapered chute 39 to facilitate delivery of the coffee beans from a hopper 20 to the grinder assembly 34. In some implementations, the hopper motor may be a component of the hopper assembly 8 (e.g., hopper retainer 22) but not the hoppers 20.

Each of the hoppers 20 or a subset of the hoppers 20 may be in communication with a single grinder assembly 34. Use of a single grinder assembly 34 for all of the hoppers collectively can reduce the cost of goods, reduce points of failure, and reduce the size of the coffee brewing system 2.

The grinder assembly 34 is configured to grind the coffee beans into grounds and may be configured to provide a controlled grind size. The grinder assembly 34 can include a grinder adjustment mechanism to automatically adjust the grind size based on the selected beverage. Further, the grinder assembly 34 can also include various safety features to undo jams or prevent operation when the grinder assembly 34 is not correctly positioned in the coffee brewing system 2.

The brewing assembly 36 is configured to brew the coffee beverage using hot water and the coffee grounds from the grinder assembly 34. The brewing assembly 36 then delivers the prepared coffee beverage to the dispensing assembly 16.

With reference to FIG. 1C, one or more power cables 37a, 37b can connect to the rear side of the coffee brewing system 2 to deliver electricity to the coffee brewing system 2. The coffee brewing system 2 can also include a number of vents 41 for cooling the coffee brewing system 2. The rear side of the coffee brewing system 2 can also include a number of Ethernet or USB ports 42 to transfer information to and from the coffee brewing system 2, for example, to form a daisy chain. As another example, information related to the usage of the coffee brewing system 2 can be transferred to a central database for mining data. In yet another example, software updates can be transferred to the coffee brewing system 2. The coffee brewing system 2 can also communicate with other coffee brewing systems, for example, to coordinate power usage. Further, the coffee brewing system 2 can include a circuit breaker 43 disposed on the rear side of the coffee brewing system 2.

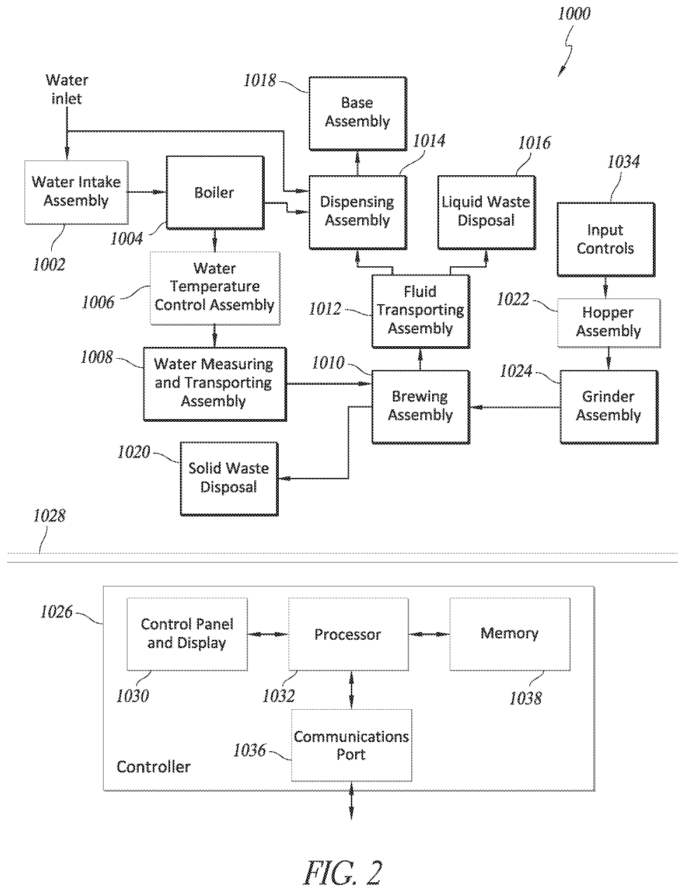

Although the coffee brewing system 2 is described with certain features, one or more of the assemblies or components described above may be omitted, replaced, consolidated, or divided among multiple subassemblies. Additional structural and operational features described below in connection with FIG. 2 or in U.S. Pat. No. 9,930,987, previously incorporated by reference, can also be included.

FIG. 2 is a schematic block diagram of a beverage apparatus 1000 for brewing a beverage. The components of the beverage apparatus 1000 may be implemented in the coffee brewing system 2. Although the beverage apparatus 1000 and coffee brewing system 2 may brew beverages (e.g., tea, cocoa) other than coffee, for purposes of explanation the structure and operation of the beverage apparatus 1000 are described in conjunction with a machine brewing coffee (e.g., the coffee brewing system 2).

The beverage apparatus 1000 can include a water intake assembly 1002. The water intake assembly 1002 can include a water filter to filter the water that is used to brew the beverage. However, the water filter may not be necessary if the coffee brewing system 2 is installed in an establishment that has a water-purification system separate from the machine. The water intake assembly 1002 can include a heat sink through which water can flow. The heat sink can dissipate such conductive or radiant heat by transferring the heat to the water passing through the heat sink. Transfer of heat to the water can preheat the water before it enters a boiler 1004. Preheating the water before it enters the boiler 1004 can reduce the power requirements for the boiler 1004 and/or other components within the coffee brewing system 2. At least some water can flow directly to the boiler 1004 and bypass the water intake assembly 1002, if present.

The boiler 1004 can receive and store water from the water intake assembly 1002 and heat the stored water to a desired temperature, for example to a temperature in the range from 150° F. to just below the boiling point of water, such as between about 190° F. and about 200° F.

The beverage preparation apparatus 1000 can include one or more sensors to measure the water temperature in the boiler 1004 or flowing from the boiler 1004. For example, the beverage apparatus 1000 can include a water temperature control assembly 1006 that can alter the temperature of the water from the boiler 1004 to provide different brew temperatures from cup to cup. The water temperature control assembly 1006 can receive water from the boiler 1004 during a brewing cycle, and, in response to the controller 1026, can adjust the temperature of the water received from the boiler 1004. The water temperature control assembly 1006 can mix the heated water from the boiler 1004 with colder water from the water intake assembly 1002 or water inlet to lower the temperature of the water used to brew the beverage. The water temperature control assembly 1006 may include a heat exchanger that allows the cold water to cool the heated water without actually mixing with the heated water. The water temperature control assembly 1006 may also be able to heat the water used to brew the beverage above the temperature of the water in the boiler 1004.

The water temperature control assembly 1006 can sense the temperature of a fluid in the brew chamber. Based on the sensed temperature, the water temperature control assembly 1006 can control the temperature of water flowing into the brew chamber. For example, if the temperature of the fluid in the brew chamber is too high, cool water can be directed to the brewing assembly 1010. If the temperature of the fluid in the brew chamber is too low, hot water can be directed to the brewing assembly 1010.

Alternatively, the beverage apparatus 1000 may not include a water temperature control assembly 1006 and depend on the boiler 1004 to heat the water to the desired temperature.

The water measuring and transporting assembly 1008 transports a predetermined amount of water from the temperature control assembly 1006 to the brewing assembly 1010 during a brewing cycle. The brewing assembly 1010 can receive heated water from the water measuring and transporting assembly 1008, receive ground material from the grinder assembly 1024, brew a beverage, and then provide the brewed beverage to the dispensing assembly 1014 via the fluid transporting assembly 1012.

The water measuring and transporting assembly 1008 may not include a pump and may rely on gravity and/or external fluid line pressure to move fluid to the brewing chamber 1010. The controller 1026 can determine the amount of water provided to the brewing assembly 1010 based on a number of flow meters in the beverage apparatus 1000. However, the water measuring and transporting assembly 1008 can include a pump for directing water to the brewing assembly 1010. The controller 1026 can determine the amount of water that the provided to the brewing assembly 1010 based on the pump rate and the amount of time that the pump is active.

The water measuring and transporting assembly 1008 can also transport a predetermined amount of water to the brewing assembly 1010 during a cleaning cycle. The brewing assembly 1010 can also include a cleaning system, such as a plow assembly, to move spent ground material and residue from the brewing assembly 1010 to the solid waste disposal 1020. The solid waste disposal 1020 may include a receptacle that one periodically removes for emptying, or that is connected to an electronic garbage disposer or directly to the sewer line of the establishment in which the coffee brewing system 2 is installed. In addition, the solid waste disposal 1020 may be connected to receive tap water, and may use the tap water to flush “ground-through” and spent coffee from the disposal unit into the garbage disposer unit or directly into the sewer line. The solid waste disposal 1020 may periodically commence an automatic flushing sequence, e.g., after brewing each cup of coffee, or may commence the flushing sequence manually. In some implementations, the solid waste disposal 1020 is the same as the liquid waste disposal 1016.

The beverage apparatus 1000 can include a fluid transporting assembly 1012 to direct the beverage to the dispensing assembly 1014 and/or liquid waste to the liquid waste disposal 1016 (e.g., waste bin or drain). The fluid transporting assembly 1012 can include a valve or valve assembly that can transition between a first valve position wherein fluid communication is provided between the interior of the brewing assembly 1010 and the dispenser assembly 1014, and a second valve position wherein fluid communication is provided between the brewing assembly 1010 and the liquid waste disposal 1016. The fluid transporting assembly 1012 may respond to the controller 1026 to move between the first and second valve positions.

The dispensing assembly 1014 can include one or more dispensers. For example, the dispensing assembly 1014 can include a beverage dispenser that can dispense a selected beverage. The dispensing assembly 1014 can include a water dispenser. The water dispenser may include one or more fluid inlets connected to the boiler 1004 and/or a water source external to the apparatus 1000. The dispensing assembly 1014 can include one or more valve assemblies to control fluid inflow and outflow.

The base assembly 1018 can hold or receive a container while the dispenser assembly 1014 fills the container with the brewed beverage (or water as described below). The base assembly 1018 can include a drain portion to absorb, e.g., spillage from the cup and drippings from the dispenser assembly 1014. The drain portion may be removable for emptying, connected to the liquid waste disposal 1016, or connected directly to the sewer line of the establishment in which the coffee beverage system 2 is installed. The base assembly 1018 can include a container-sensing unit (not shown) to indicate to the controller 1026 whether a container is present in the base assembly 1018. If the container is not present after the brewing assembly 1010 has brewed the beverage, then the controller 1026 may deactivate or close the fluid transporting assembly 1012 to prevent the dispense of the brewed beverage. As another example, if the container is present during a cleaning cycle, then the controller 1026 may deactivate or close the fluid transporting assembly 1012 to prevent rinse water from dispensing into the container. The cup-sensing unit may include any type of sensor, such as an optical, mechanical, or ultrasonic sensor.

The beverage apparatus 1000 may include one or more hopper assemblies 1022 for holding beverage material, which are fed to the grinder assembly 1024. The controller 1026 may indicate the amount of beverage material to be delivered to the grinder assembly 1024. Where the coffee brewing system 2 includes multiple hopper assemblies 1022, then one can load different types of beverage material into each hopper assembly 1022.

In response to the controller 1026, the grinder assembly 1024 can grind beverage material from the hopper assembly 1022, and then provide to the brewing assembly 1010 a predetermined amount of ground material. The controller 1026 may indicate one of multiple grind sizes (e.g., coarse, normal, fine) to the grinder assembly 1024, as the grind size may affect the taste and other characteristics of the brewed coffee.

The beverage apparatus 1000 can include a barrier 1028 to separate the controller 1026 and associated circuitry from other components of the apparatus 1000. For example, steam from hot water and brewing the beverage may condense and damage or otherwise render inoperable the controller 1028. Furthermore, condensation on the conduits that carry cold tap water may cause similar problems. Therefore, a moisture barrier 1028 helps keep the controller 1026 and associated circuitry dry.

The controller 1026 controls the operation of some or all of the other components of the beverage apparatus 1000 as discussed above, and includes a processor 1032, a memory 1038, a control panel and display 1030, and a communications port 1036.

The processor 1032 executes a software program stored in the memory 1038 or in another memory (not shown), and controls the operations of the components of the beverage apparatus 1000 as described above and as described below.

In addition to storing one or more software programs, the memory 1038 may store sets of predetermined brew parameters or recipes as discussed in further detail below. The memory 1038 can also store data associated with machine activity (e.g., number of brewed beverages, types of brewed beverages or sizes of brewed beverages).

The control panel and display 1030 allows an operator to enter brewing options (e.g., coffee type, cup size, and brewing parameters) or to select brewing options from a menu that the processor 1032 may generate on the display. For example, the operator may select via the control panel and display 1030 individual brewing parameters (e.g., grind size, water temperature, brewing time, and the coffee-ground-to-water ratio), or a set of predetermined brewing parameters stored in the memory 1038. As an example of the latter, a coffee roaster may have determined preferred brewing parameters for its coffee. One may then store these preferred parameters in the memory 1038 as a set, and associate the set with an identifier, such as the name or type of the coffee. Therefore, instead of entering or selecting each brewing parameter individually, which may be tedious, the operator merely enters or selects from a menu the identifier, and the controller 1026 causes the beverage apparatus 1000 to brew coffee according to the set of parameters corresponding to the identifier.

In some embodiments, instead of or in addition to the control panel and display, the beverage apparatus 1000 can include a number of other input controls 1034 for selecting brewing options.

The communications port 1036 allows the processor 1032, memory 1038, and control panel and display 1030 to communicate with one or more devices external to the beverage apparatus 1000. For example, the port 1038 may be connected to a computer so that one can program or run diagnostics from the computer. The port 1038 may also be connected to another beverage apparatus 1000 to communicate information (e.g., brewing parameters or power supply information). As another example, the port 1036 may be connected to the internet, so that one can download into the memory 1038 data such as sets of brewing parameters or upload usage statistics from the beverage apparatus 1000. In addition, the port 1036 may receive data via a wireless channel, such as a set of brewing parameters from a RFID tag or a barcode on a container of coffee or on a coffee cup (the tag may hold the cup owner's preferred coffee type, cup size, or brew parameters). Furthermore, the port 1036 may allow the processor 1032 to download demographic information, such as coffee-drinker preferences and number of cups brewed, to a coffee roaster or supplier or to the manufacturer/supplier of the beverage apparatus 1000.

Many of the features described herein, including, but not limited to, grind size adjustment, the brewing assembly, the water input system, the beverage dispensing features, and the plow assembly, are designed to brew beverages quickly. Existing brew processes for individual serving portions (e.g., single-cup portions) of a beverage often take more than 60 seconds. In contrast, the coffee brewing system 2 described herein can grind, brew, and dispense an individual serving portion (e.g., single-cup portion) of a beverage in about 60 seconds or less, such as less than 40 seconds, less than about 35 seconds, or less than about 30 seconds. In some embodiments, the coffee brewing system 2 can dispense the individual serving portion (e.g., single-cup portion) portion in less than about 10 seconds or less than about 5 seconds. Further, in some embodiments, the reset process, including cleaning the brewing assembly can also take about 30 seconds or less.

Alternate embodiments of the beverage apparatus 1000 are contemplated. For example, one or more of the above-described units or components may be omitted, the function of multiple units may be consolidated into fewer units, or the function of a single unit may be divided among multiple units.

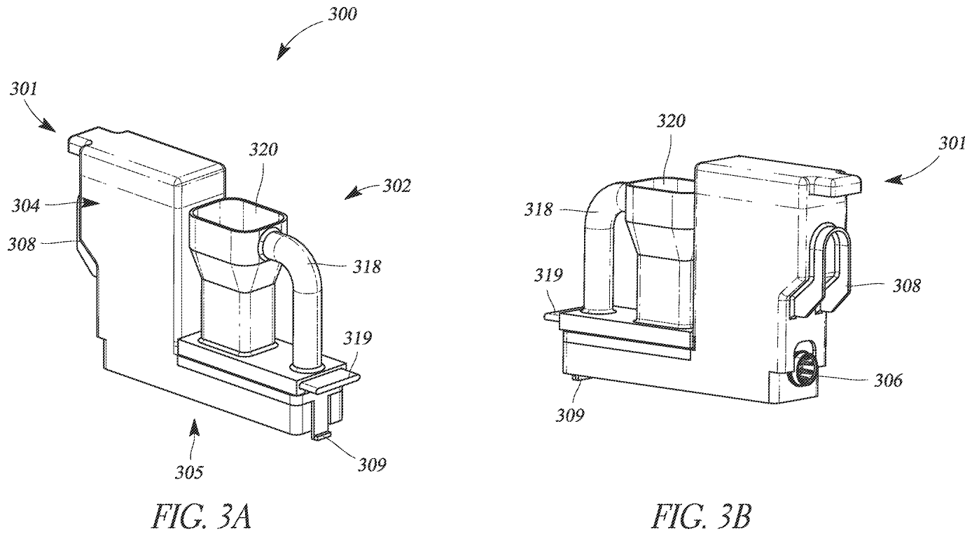

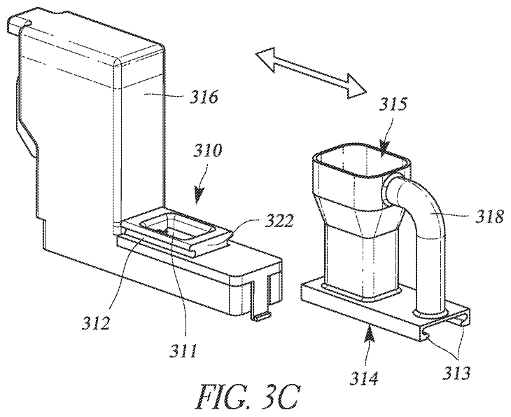

Turning to FIGS. 3A-3C, an embodiment of a bulk hopper replacement unit, or individual serving feed hopper adapter, 300 that may be used with an automated bulk beverage preparation system or apparatus (e.g., coffee brewing system 2 and/or beverage apparatus 1000) is shown. The individual serving feed hopper adapter 300 includes two main components, or modules: an adapter component 301 and a vessel component 302. While two main components may be particularly advantageous, additional intermediate components can be used or the two main components can be subdivided into subcomponents.

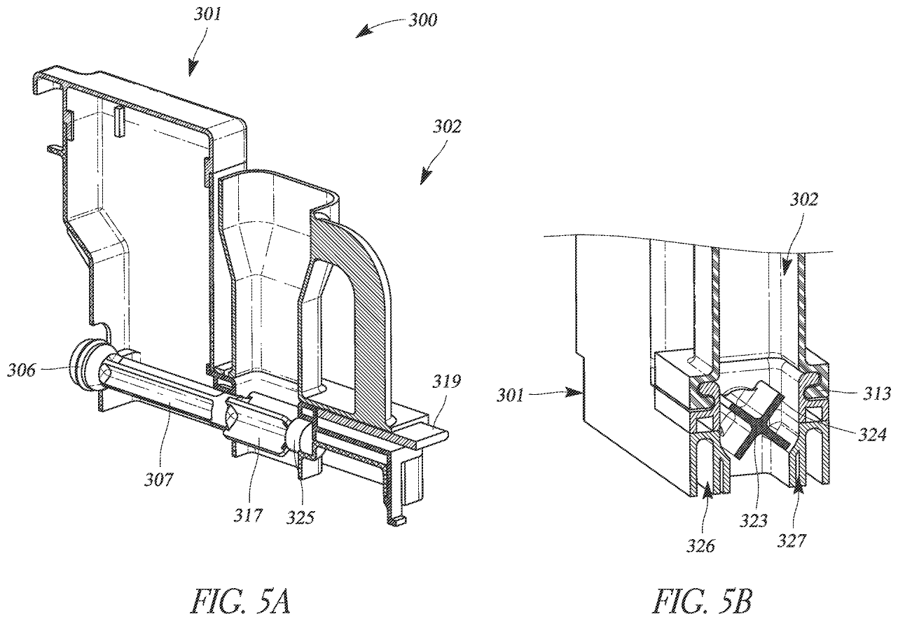

The adapter component 301 is a mounting dock adapted to mount onto or into an open bulk hopper slot of an automated bulk brewing system (e.g., hopper retainer 22 of coffee brewing system 2) as a replacement for a bulk hopper. The adapter component 301 may include the same mating or engagement features as a bulk hopper. The adapter component 301 can include an outer housing 303 having a rear portion 304 and a front portion 305. The rear portion 304 may be generally vertical and the front portion may be generally horizontal to generally form an “L” shape. The rear portion 304 can include structural features sized and shaped to allow the adapter component 301 to mate or engage with corresponding structural features of a hopper slot of an automated bulk brewing system (e.g., hopper assembly 8 of coffee brewing system 2) so as to facilitate preparation of a beverage (e.g., brewing of a coffee beverage) using the automated bulk brewing system (e.g., coffee brewing system 2). For example, the rear portion 304 of the adapter component 301 can include an auger coupling 306 adapted to couple an adapter auger 307 (shown in FIG. 5A) to a hopper motor of the automated bulk brewing system (e.g., hopper motor 34 of coffee brewing system 2). In some implementations, the adapter component 301 may include the hopper motor coupled to the auger coupling 306.

With reference to FIG. 3B, the rear portion 304 may also include a rear coupler 308 adapted to interface with corresponding structures of the hopper slot of an automated bulk brewing system such that the adapter component 301 is suitably engaged with (e.g., installed on or in) the hopper slot. As best shown in FIG. 3A, a front portion 305 of the adapter component 301 may include a tab 309 configured to facilitate engagement of the adapter component 301 with the hopper slot or to facilitate initiation of easy removal of the adapter component 301 from the hopper slot. The adapter component 301 may for all intents and purposes appear to the automated bulk brewing system (e.g., coffee brewing system 2) as if a bulk hopper is connected instead of the bulk hopper replacement unit.

With reference to FIG. 3C, an upper surface of a platform of the front portion 305 of the adapter component 301 may include an engagement member 310. The engagement member 310 includes a central opening 311. The engagement member 310 includes slots or grooves 312 formed on each lateral side of the engagement member 310. The slots or grooves 312 are adapted to receive corresponding rails 313 formed on and extending from a lower portion 314 (e.g., horizontal platform) of the vessel component 302. The inner surfaces of the rails 313 may be rounded to facilitate insertion within and sliding movement along the slots or grooves 312. The rails 313 are adapted to be inserted within and slide along the slots or grooves 312 of the engagement member 310 of the adapter component 301 as the vessel component 302 is advanced horizontally along the upper surface of the platform of the front portion 305 of the adapter component 301. The mating interface between the slots or grooves 312 and the corresponding rails 313 facilitate removable engagement or mating between the single-cup vessel component 302 and the adapter component 301. Other suitable interlocking designs or features other than those illustrated in the figures as desired and/or required. The central opening 311 is adapted to be aligned with a corresponding lower opening at a bottom of a storage vessel, or container, 315 of the vessel component 302 when the vessel component 302 is fully advanced along the engagement member 310 (e.g., into contact with a front wall 316 of the rear portion 303). As shown and described in further detail in connection with FIG. 5A, the adapter component 301 includes a feed auger 317 positioned below the central opening 311. The feed auger 317 is operably coupled to the adapter auger 307 to facilitate rotation of the feed auger 317.

The vessel component 302 comprises the storage vessel 315, a handle 318, and a retention member 319. The storage vessel 315 comprises an upper opening 320 adapted to receive coffee beans (or other beverage contents) and a lower opening 321 adapted to align with the central opening 311 of the adapter component 301 to facilitate release of the coffee beans toward the feed auger 317 when the retention member 319 is moved so as not to be blocking or covering the lower opening 321. As shown, the upper opening 320 is larger than the lower opening 321 and there is a tapering of a cross-sectional dimension between the upper opening 320 and the lower opening 321 along a height of the storage vessel 315. The larger upper opening 320 may facilitate easier insertion of coffee beans without spilling. In other embodiments, the storage vessel 315 may have a uniform or generally uniform cross-sectional dimension along its height. The storage vessel 315 may define an interior volume that is sized to receive enough coffee beans to prepare an individual serving portion (e.g., single-cup portion) of coffee. In some implementations, the interior volume may be sized to receive enough coffee beans to prepare a traveler-size portion (e.g., multiple single-cup portions) of coffee. The handle 318 is adapted to facilitate easy grasping and transport of the vessel component 302 by a single hand of a barista or other user.

Although reference is made throughout this disclosure to “single-cup” portions or “individual serving” portions, the individual serving feed hopper adapter, or bulk hopper replacement unit, 300 may be adapted and used to prepare desired portions using storage containers (e.g., hoppers, vessels) sized to hold smaller portions of beverage contents (e.g., coffee beans) than the bulk hoppers 20. For example, the individual serving portions or single-cup portions may be a portion or serving size appropriate for consumption by a single individual that are more or less than an actual cup (i.e., 8 fluid ounces) of the beverage (e.g., 4 fluid ounces to 24 fluid ounces, 4 fluid ounces to 16 fluid ounces, 8 fluid ounces to 24 fluid ounces). The individual serving portions may be traveler portions (e.g., multiple-cup portions, such as 1 to 4 individual serving sizes, or up to 96 fluid ounces) in some implementations. In accordance with several implementations, the storage vessel 315 may define an interior volume (e.g., a maximum storage capacity) that is less than 20% (1:5 ratio), less than 15% (3:20 ratio), less than 10% (1:10 ratio), or less than 5% (1:20 ratio) of the interior volume of the bulk hopper 20 that the bulk hopper replacement unit, or individual serving feed hopper adapter 300, is replacing. The ratio of the interior volume of the storage vessel 315 to the interior volume of the bulk hopper 20 may be between 1:100 and 1:5 (e.g., between 1:100 and 1:20, between 1:50 and 1:20, between 1:50 and 1:10, between 1:20 and 1:10, between 3:20 and 1:20, between 1:10 and 1:5). The storage vessel 315 may be sized (e.g., have a maximum storage capacity) to receive less than 20%, less than 15%, less than 10%, or less than 5% of the amount of coffee beans that the bulk hopper 20 is sized to receive (e.g., maximum storage capacity). The storage vessel 315 may be sized to have a maximum storage capacity of between 15 grams and 250 grams (e.g., between 15 grams and 60 grams, 60 grams or less, 250 grams or less, between 20 grams and 60 grams, between 30 grams and 60 grams, between 15 grams and 100 grams, overlapping ranges thereof, or any value within the recited ranges) of coffee beans. “Maximum storage capacity” may have its plain and ordinary meaning and may include, for example, a capacity above which the coffee beans in the storage vessel 315 would be overflowing, or spill out, such that they cannot be contained within the storage vessel. In certain implementations, the storage vessel 315 may be sized to receive between 15 grams and no more than 250 grams (e.g., between 15 grams and no more than 60 grams, no more than 60 grams, no more than 250 grams, between 20 grams and no more than 60 grams, between 30 grams and no more than 60 grams, between 15 grams and no more than 100 grams, overlapping ranges thereof, or any value within the recited ranges) of coffee beans.

In some implementations, a bulk hopper having a first maximum storage capacity is replaced with the individual serving feed hopper adapter, or bulk hopper replacement unit, 300, wherein the storage vessel 315 of the individual serving feed hopper adapter 300 has a second maximum storage capacity. The second maximum storage capacity may be less than the first maximum storage capacity. For example, the second maximum storage capacity may have a maximum storage capacity as set forth in the preceding paragraph. A barista or other user may fill the storage vessel 314 with less than 20% (1:5 ratio), less than 15% (3:20 ratio), less than 10% (1:10 ratio), or less than 5% (1:20 ratio) of the amount of coffee beans that the bulk hopper is sized to store (e.g., maximum storage capacity of the bulk hopper). A barista or other user may fill or load the storage vessel 314 with between 15 grams and 250 grams (e.g., between 15 grams and 60 grams, 60 grams or less, 250 grams or less, between 20 grams and 60 grams, between 30 grams and 60 grams, between 15 grams and 100 grams, overlapping ranges thereof, or any value within the recited ranges) of coffee beans. The amount of coffee beans may be an amount sufficient to brew a coffee beverage of 3 fluid ounces to 96 fluid ounces (e.g., from 3 fluid ounces to 20 fluid ounces, from 3 fluid ounces to 30 fluid ounces, from 8 fluid ounces to 30 fluid ounces, from 8 fluid ounces to 64 fluid ounces, overlapping ranges thereof, or any value within the recited ranges such as 3 fluid ounces, 4 fluid ounces, 8 fluid ounces, 12 fluid ounces, 16 fluid ounces, 20 fluid ounces, 30 fluid ounces, 31 fluid ounces, 48 fluid ounces, 96 fluid ounces). The storage vessel 314 may be filled prior to or after docking or engaging of the individual serving feed hopper adapter, or bulk hopper replacement unit, 300 with the bulk hopper slot of the automated coffee brewing system. The automated coffee brewing system may then be activated (manually or automatically) to brew the individual serving portion of coffee using the amount of coffee beans inserted in the storage vessel 314 by the barista or other user.

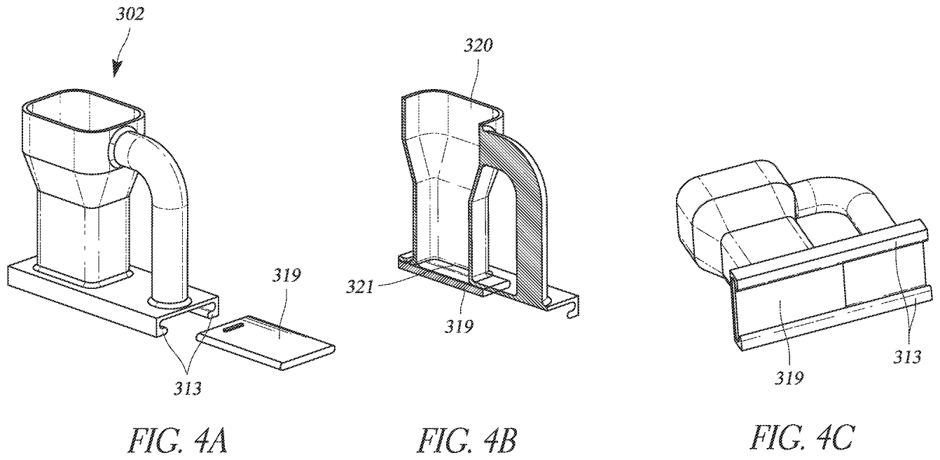

With reference to FIGS. 4A-4C, the retention member 319 may be sized and shaped to fit into the slots or grooves formed above the rails 313 of the vessel component 302 and to slide along the slots or grooves along the rails 313. The lateral sides of the retention member 319 may be rounded to facilitate insertion into and sliding within the slots or grooves along the rails 313. The retention member 319 may be partially or completely removed from the slots or grooves (as shown in FIG. 4A). As shown in FIGS. 4B and 4C, the retention member 319 may be advanced distally until the retention member 319 covers the lower opening 321 at the bottom of the storage vessel 315, thereby retaining (or preventing dispensing or release of) coffee beans or other beverage ingredients loaded therein.

As shown in FIG. 3A, advancement of the vessel component 302 distally along the upper surface of the platform of the front portion 305 and toward the wall 316 of the rear portion 304 of the adapter component 301 causes the retention member 319 to be automatically slid proximally (toward the front, or toward a barista) along the slots or grooves above the rails 313 as the retention member 319 comes in contact with a front (e.g., proximal) portion 322 of the engagement member 310 protruding upward from the upper surface of the platform of the front portion 305 of the adapter component 301, thereby uncovering the lower opening 321 and allowing the coffee beans to fall down through the central opening 311 toward the feed auger 317 in the adapter component 301.

In some implementations, there is no biasing member (e.g., spring) to cause the retention member 319 to automatically return to a closed (or locked) configuration in which the lower opening 321 of the storage vessel 315 is covered. In some implementations, there is no magnetic assembly or other actuation mechanism to controllably transition the retention member 319 between a closed and open configuration. Instead, the retention member 319 is transitioned between configurations by mechanical or physical contact brought about by manual force. Thus, the retention member 319 may not have a default configuration.

In other implementations, there may be a biasing member (e.g., spring) to cause the retention member 319 to automatically return to a closed (or locked) configuration in which the lower opening 321 of the storage vessel 315 is covered. Thus, the retention member 319 may have a default closed or locked configuration.

FIGS. 5A and 5B illustrate an embodiment of an auger assembly of the bulk hopper replacement unit, or individual serving feed hopper adapter, 300. The auger assembly includes the auger coupling 306, the adapter auger 307, and the feed auger 317. The adapter auger 307 and the feed auger are mechanically and operably coupled such that rotation of the adapter auger 307 (e.g., by the hopper motor 34) causes corresponding rotation of the feed auger 317. The feed auger 317 can advantageously prevent coffee beans from entering the grinder assembly 34 positioned below the feed auger 317 until the auger turns such that the coffee beans can be metered into the grinder assembly 34 at a certain rate.

FIG. 5B shows a cross-section view that helps illustrate the cross-section of the feed auger 317. As shown, the feed auger 317 may comprise a flat paddle wheel design including an inner core 323 and blades or flutes 324 at least partially surrounding the inner core 323. However, in some implementations, the feed auger 317 may comprise angled or wavy blades or flutes 324 designed to reduce required and/or desired driving force and noise. The hopper motor 34 can turn the adapter auger 307 in a clockwise or counter-clockwise direction, which in turn, can turn the feed auger 317. In some implementations, the hopper motor 34 is a component of the auger assembly of the adapter component 301. An auger retainer 325 at a proximal end of the feed auger 317 can secure the proximal end of the feed auger 317 within a slot of the adapter component 301.

FIG. 5B also illustrates that a bottom portion of the adapter component 301 can include one or more engagement features 326, 327 (e.g., lip, ridge, protrusion, indentation, groove, or opening) that can extend intermittently or continuously along at least a portion of a bottom portion of the adapter component 301. The engagement features 326, 327 are adapted to facilitate engagement with mating or interface features of a hopper slot of the automated bulk brewing system (e.g., coffee brewing system 2). In some implementations, the adapter component 301 is slid distally in a generally horizontal (e.g., non-vertical) direction onto or into a hopper slot. In other implementations, the adapter component 301 is docked from a generally vertical direction and dropped onto or into the hopper slot, FIG. 5B further shows a close-up view of how the rails 313 of the vessel component 302 fit within the corresponding slots or grooves 312 of the engagement member 310 of the adapter component 301.

The blades or flutes 324 may be evenly distributed around a circumference of the inner core 323. The inner core 323 and blades 324 can include a same material or different materials. For example, the inner core 323 can include stainless steel and the blades 324 can be injection molded around the inner core 323 using nylon, PVC, polymers, ceramics, or any combination thereof. As another example, the inner core 323 and the blades 324 can each include nylon, PVC, polymers, ceramics, or any combination thereof.

Manufacturing the feed auger 317 can include a two-step injection molding process. First, the inner core 323 can be injection molded using nylon, PVC, polymers, ceramics, or any combination thereof. After the inner core 323 cools, the blades 324 can be injection molded over the inner core 323 using nylon, PVC, polymers, ceramics, or any combination thereof.

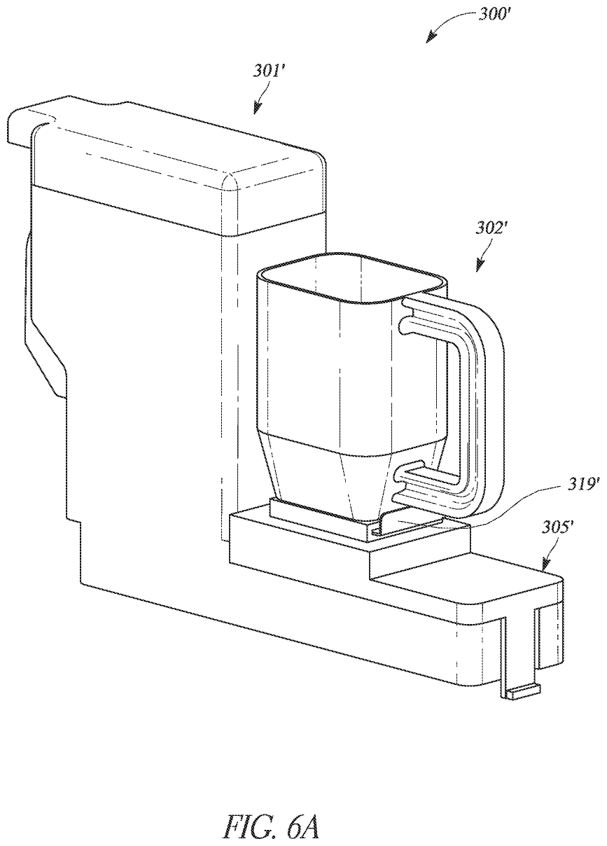

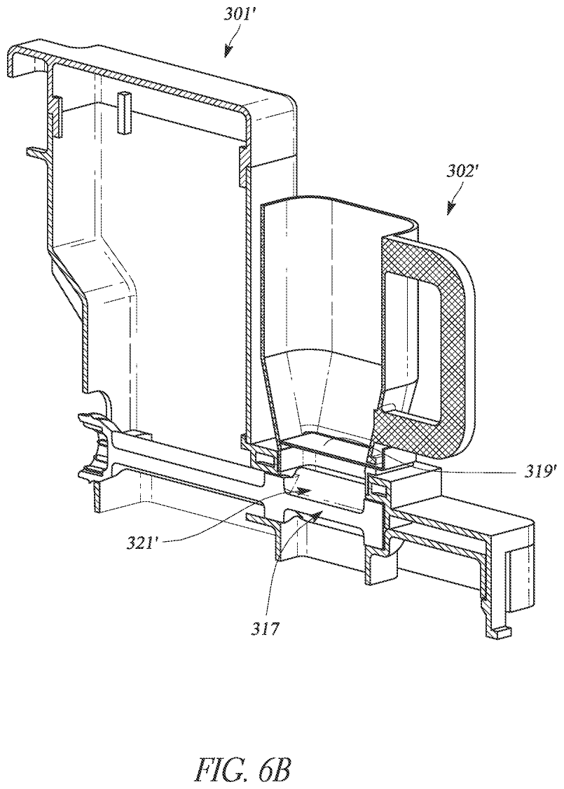

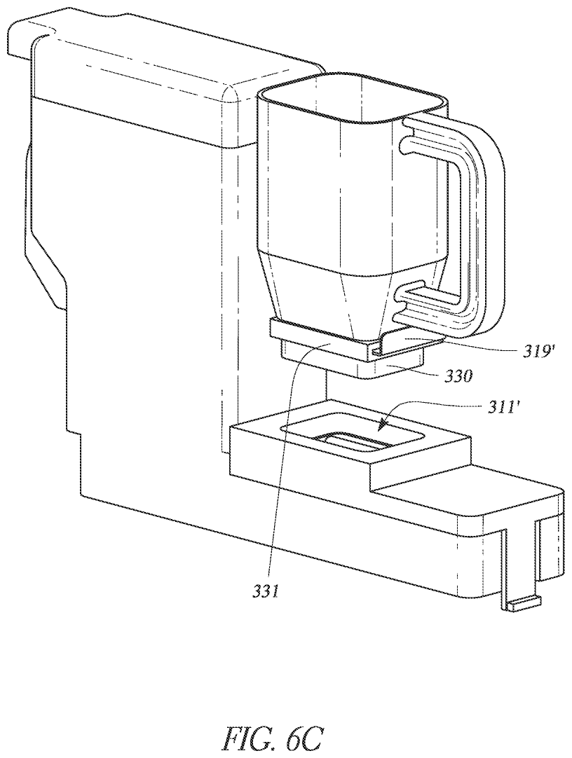

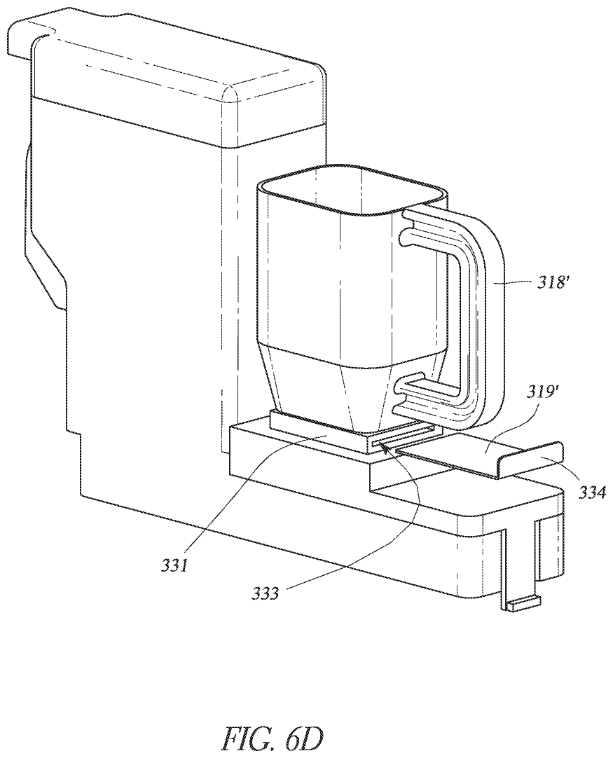

FIGS. 6A-6D illustrate another embodiment of a bulk hopper replacement unit, or individual serving feed hopper adapter, 300′ that may be used in conjunction with an automated bulk coffee brewing system, such as the automated coffee brewing system 2 illustrated in FIGS. 1A-1E. FIG. 6A is a side perspective view of the bulk hopper replacement unit, or individual serving feed hopper adapter, 300′ and FIG. 6B is a side cross-section view of FIG. 6A.

The bulk hopper replacement unit, or individual serving feed hopper adapter, 300′ may include similar structural and operational features as the bulk hopper replacement unit, or individual serving feed hopper adapter, 300 described in connection with FIGS. 3A-5B. For example, the bulk hopper replacement unit 300′ includes an adapter component 301′ and a vessel component 302′ that may include similar structural and operational features as the adapter component 301 and vessel component 302 described above. The vessel component 302′ also includes a removable retention member 319′ (e.g., gate or other retention mechanism) that may provide a retention function similar to the retention member 319 described above.

However, the vessel component 302′ may be adapted to engage, dock, or mate with the adapter component 301′ from a generally vertical direction instead of a generally horizontal direction (e.g., a top-load implementation instead of a side-load implementation). FIG. 6C shows a vessel component 302′ positioned above a central opening 311′ formed in a raised upper surface of a platform of a front portion 305′ of the adapter component 301′. The central opening 311′ is sized and shaped to receive a distal docking member or portion 330 of the vessel component 302′. The distal docking member 330 is inserted into the central opening 311′ in a generally vertical trajectory from a position above the central opening 311′. The vessel component 302′ also includes a proximal docking member or portion 331 sized and shaped to be larger in length and width than the central opening 311′ of the adapter component 301′ (and than the distal docking member 330) such that a lower circumferential surface of the proximal docking member 331 rests on the raised upper surface of the platform of the front portion 305′ of the adapter component 301′. The proximal docking member 331 includes a slot 333 sized and shaped to receive the retention member 319′. Similarly as described in connection with the retention member 319, when the retention member 319′ is fully inserted within the slot 333, any contents (e.g., coffee beans) within the vessel component 302′ are retained in the vessel component 302′. However, upon the act of removing the retention member 319′ from the slot 333 (partially or completely), the contents of the vessel component 302′ are no longer retained in the vessel component 302′ and may enter (e.g., fall) into the central opening 311′ of the adapter component 301′ and then into the feed auger 317.

FIG. 6D shows the retention member 319′ in an open, or removed, configuration in which any contents of the vessel component 302′ are no longer prevented from entering the central opening 311′ of the adapter component 301′. As shown, the retention member 319′ may be inserted and removed from a side of the proximal docking member 331 facing a handle 318′ of the vessel component 301′. The retention member 319′ may have a length and width sized to completely cover a lower opening 321′ of the vessel component 302′ so as to prevent release or discharge of any contents when the retention member 319′ is fully inserted within the slot 333.

A first end of the retention member 319′ may include a gripping member 334 extending substantially perpendicular to the first end of the retention member so as to facilitate insertion and removal of the retention member 319′ into and out of the slot. The gripping member 334 may also prevent over-insertion of the retention member 319′. The gripping member 334 may alternatively comprise a knob that does not necessarily extend perpendicular to the first end of the retention member. In accordance with several implementations, the retention member 319′ is manually inserted and removed from the slot (e.g., via pushing and pulling on the gripping member 334) and is not automatically transitioned between a closed configuration and open configuration upon docking or mating of the vessel component 302′ with the adapter component 301′. The retention member 319′ may not be automatically biased in a closed configuration.

In other implementations, operation of the retention member 319′ could be automated (in one or both directions). For example, a mechanical cam system (e.g., rotating and/or sliding cam mechanism and/or crank mechanism) could be operably coupled (e.g., mechanically attached) to the retention member 319′ and to the auger assembly (e.g., feed auger 317) of the adapter component 301′ such that as the feed auger 317 rotates, the cam system causes the retention member 319′ to transition between the closed configuration and the open configuration. The cam system may comprise a one-way cam system that is reset manually (e.g., retention member 319′ is manually transitioned to the closed configuration) at a time when coffee beans or other contents are loaded into the vessel component 302′. In some implementations, the cam system is automatically reset.

### Method of Use

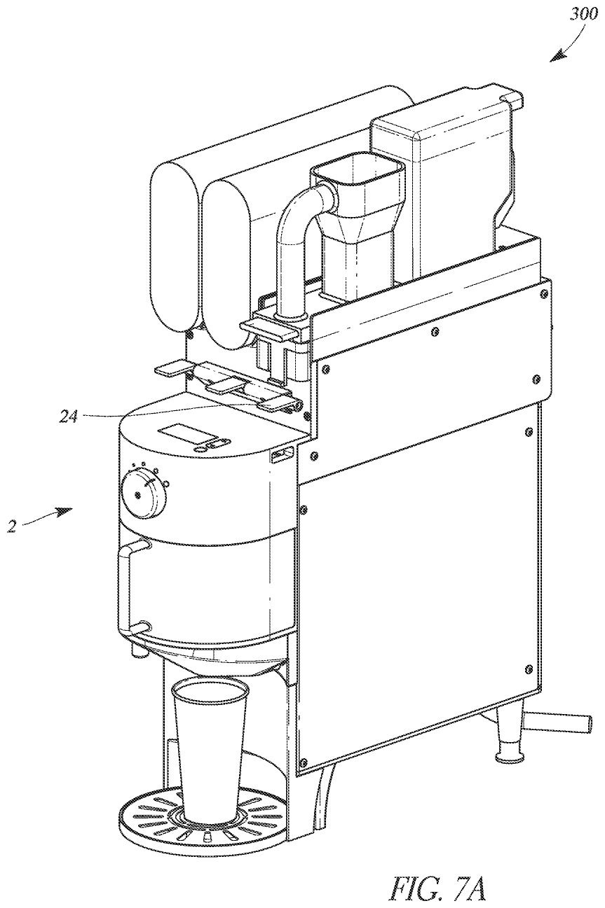

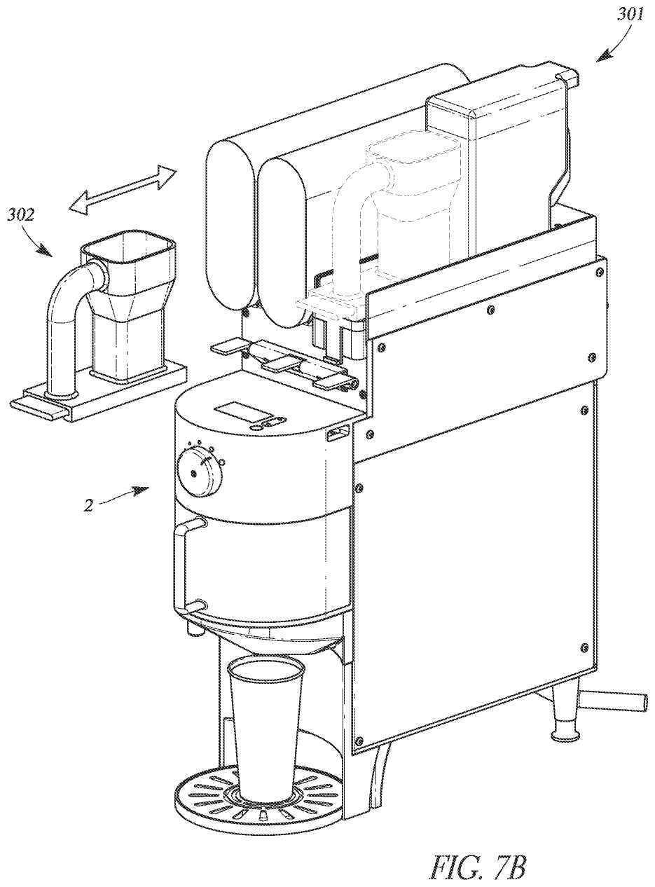

FIG. 7A illustrates an embodiment of a bulk hopper replacement unit, or individual serving feed hopper adapter, 300 mounted on a bulk hopper slot of the automated coffee brewing system 2. As shown in FIG. 7A, one of the bulk hopper slots can be occupied by the bulk hopper replacement unit, or individual serving feed hopper adapter, 300 and the other bulk hopper slots can be occupied by bulk hoppers. Of course, in some instances, multiple bulk hopper replacement units, or individual serving feed hopper adapters, 300 can be coupled to multiple bulk hopper slots as desired and/or required. In addition, multiple vessel components 302 may be pre-filled with beverage contents and lined up, or queued up, and interchangeably engaged with the adapter component 301 mounted on one of the bulk hopper slots so as to increase throughput.

The bulk hopper replacement unit, or individual serving feed hopper adapter, 300 may be selected for use by selecting the appropriate hopper selector (e.g., paddle 24) of the automated coffee brewing system 2. In some configurations, when the individual serving feed hopper adapter 300 (e.g., the adapter component 301 and/or the vessel component 302) is coupled (e.g., docked, mated, engaged) with one of the bulk hopper slots of the coffee brewing system 2, the coffee brewing system 2 immediately and automatically detects or recognizes that an individual serving feed hopper adapter 300 has been docked and causes a menu screen corresponding to the individual serving feed hopper adapter 300 to be displayed on the display screen 26. The menu screen may enable selection by a barista or user of the type of beverage (e.g., coffee) and/or other beverage parameters. In some configurations, the various options for the type of beverage (e.g., coffee) are prepopulated on the menu screen for selection based on an inventory of the beverages (e.g., coffee types) available in the coffee store. After the automated coffee brewing system 2 is activated, the bulk hopper replacement unit, or individual serving feed hopper adapter, 300 can dispense the individual serving dose (e.g., single-cup dose) of beverage material to the grinder assembly 500.

The controlled dose can enter the grinder assembly 34 via the chute 39. The grinder assembly 34 can be set to a specific grind size based on the hopper selection. After the grinder assembly 34 grinds the beverage material, the beverage material can flow into the brewing assembly 36 and then from the brewing assembly to the dispensing assembly 16 and then into a beverage container 30 placed below a discharge spout of the dispensing assembly 16. Then the vessel component 302 may be removed from the adapter component 301 (as shown in FIG. 7B) and a new vessel component 302 loaded with beverage contents (e.g., coffee beans) can be mated or engaged with the adapter component 301 and the brewing process may be repeated. The adapter component 301 may be left in place docked with the coffee brewing system 2 for an extended period of time to be ready for preparation of additional beverages or may be replaced with a bulk hopper after a single use or short period of time. The bulk hopper replacement unit, or individual serving feed hopper adapter 300′ of FIGS. 6A-6D may also additionally or alternatively be used.

Using a single grinder assembly 34 for both bulk hoppers and the individual serving feed hopper adapter 300 can reduce the amount of space required for the grinder assemblies, reduce the cost of goods, reduce points of failure, and reduce the amount of necessary calibration. The grinder assembly 34 can grind the beverage material to a controlled ground size. The ground size can vary based on a number of factors, including, but not limit to, the type of beverage material or the type of drink.

### Terminology

For expository purposes, the term “horizontal” as used herein is defined as a plane parallel to the plane or surface on which the device being described is used or the method being described is performed, regardless of its orientation. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the relative terms “proximal”, “distal”, “front” and “rear” shall be defined from a user (e.g., barista) facing the controls. Thus, proximal refers to the side of the machine with the user-operable controls and distal refers to the opposite side of the machine.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, the terms “approximately”, “about”, and “substantially” may refer to an amount that is within less than 10% of the stated amount, as the context may dictate. As another example, in certain embodiments, the terms “generally parallel” and “substantially parallel” refer to a value, amount, or characteristic that departs from exactly parallel by less than or equal to 10 degrees, as the context may dictate.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The ranges disclosed herein also encompass any and all overlap, sub-ranges, and combinations thereof. Language such as “up to,” “at least,” “greater than,” “less than,” “between” and the like includes the number recited. Numbers preceded by a term such as “about” or “approximately” include the recited numbers. For example, “about 5 inches” includes “5 inches.”

Although certain embodiments and examples have been described herein, it will be understood by those skilled in the art that many aspects of the systems and devices shown and described in the present disclosure may be differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensable.

Some embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

1. A bulk hopper replacement unit for replacing a bulk hopper of a hopper assembly of an automated coffee brewing system, the bulk hopper replacement unit comprising:
an adapter component configured to removably engage with a bulk hopper slot of the hopper assembly of the automated coffee brewing system; and
a vessel component configured to removably engage with the adapter component,
wherein the vessel component comprises a container defining an interior volume sized and shaped to hold an amount of coffee beans smaller than an amount of coffee beans capable of being stored in the bulk hopper,
wherein the adapter component comprises an opening and a feed auger disposed under the opening configured to control dispensing of the coffee beans into a grinder assembly of the automated coffee brewing system, and
wherein, when the vessel component is engaged with the adapter component, the opening of the adapter component is aligned with a lower opening of the container of the vessel component to facilitate transfer of the coffee beans into the adapter component.

2. The replacement unit of claim 1, wherein the adapter component comprises one or more hopper engagement features adapted to facilitate engagement with the bulk hopper slot of the hopper assembly of the automated coffee brewing system.

3. The replacement unit of claim 1, wherein the adapter component comprises a generally vertical rear portion and a generally horizontal front portion, wherein an upper surface of the front portion comprises an engagement member disposed thereon to facilitate engagement with the vessel component, the engagement member comprising the opening.

4. The replacement unit of claim 1, wherein the vessel component comprises a handle.

5. The replacement unit of claim 1, wherein the adapter component comprises an adapter auger operably coupled to the feed auger to control rotation of the feed auger, and wherein the adapter auger comprises an auger coupling adapted to couple to a hopper motor of the hopper assembly of the automated brewing system.

6. The replacement unit of claim 1, wherein the feed auger is positioned along the adapter component such that the feed auger is generally aligned with a grinder assembly of the automated brewing system.

7. The replacement unit of claim 1, wherein the vessel component comprises a slot positioned above the lower opening of the container, and wherein the vessel component comprises a removable retention member adapted to be inserted within the slot and sized to cover the lower opening of the container so as to retain the coffee beans within the container until the removable retention member is at least partially removed from the slot.

8. The replacement unit of claim 3, wherein the engagement member comprises notches extending along opposite lateral sides of the engagement member.

9. The replacement unit of claim 8, wherein a lower portion of the vessel component comprises inwardly-extending lateral rails adapted to fit within the notches.

10. The replacement unit of claim 9, wherein the vessel component comprises a retention member configured to be removably engaged with the lateral rails so as to retain the coffee beans within the container until the vessel component is engaged with the adapter component.

11. The replacement unit of claim 10, wherein the retention member is configured to slide along the rails between a closed configuration that prevents transfer of the coffee beans out of the container and an open configuration in which the coffee beans are no longer retained within the container.

12. The replacement unit of claim 11, wherein contact by a leading surface of the retention member with a front surface of the engagement member causes the retention member to slide proximally along the rails of the vessel component to uncover the lower opening of the container and to allow the coffee beans to transfer to the adapter component.

13. A bulk hopper replacement unit for replacing a bulk hopper of a hopper assembly of an automated coffee brewing system, the bulk hopper replacement unit comprising:
an adapter component configured to removably engage with a bulk hopper slot of the hopper assembly of the automated coffee brewing system; and
a vessel component configured to removably engage with the adapter component,
wherein the vessel component comprises a container defining an interior volume sized have a maximum storage capacity of less than 250 grams of coffee beans,
wherein the vessel component comprises a removable gate that is caused to be moved from a closed configuration to an open configuration, thereby allowing the coffee beans to exit the container.

14. The replacement unit of claim 13, wherein the removable gate is slidably attached to the vessel component.

15. The replacement unit of claim 14, wherein contact by a leading surface of the removable gate with a front surface of an engagement member on the adapter component causes the retention member to slide proximally to the open configuration.

16. The replacement unit of claim 15, wherein the adapter component comprises an opening and the container of the vessel component comprises a lower opening that are configured to be aligned when the vessel component is fully engaged with the adapter component and the removable gate has been moved to the open configuration.

17. The replacement unit of claim 13, wherein the removable gate is not automatically biased in the closed configuration.

18. A method of preparing an individual serving portion of a coffee beverage using an automated coffee brewing system comprising a bulk hopper assembly, the method comprising:
removably installing an adapter component of a bulk hopper replacement unit on a bulk hopper slot of the bulk hopper assembly of the automated coffee brewing system;
filling a vessel component of the single-cup feed hopper replacement unit with an amount of coffee beans sufficient for preparation of an individual serving portion of a coffee beverage;
coupling the vessel component to the adapter component; and
activating the automated coffee brewing system to prepare the coffee beverage.

19. The method of claim 18, further comprising:
removing the vessel component from the adapter component;
filling a second vessel component with an amount of coffee beans sufficient for preparation of an individual serving portion of a second coffee beverage;
coupling the second vessel component to the adapter component; and
activating the automated coffee brewing system to prepare the second coffee beverage.

20. The method of claim 18, wherein activating the automated coffee brewing system comprises activating a hopper selector of the bulk hopper assembly corresponding to the bulk hopper slot in which the adapter component is installed.

21. The method of claim 18, further comprising removing the adapter component from a bulk hopper slot of the bulk hopper assembly of the automated coffee brewing system.
